(19) United States
(12) Patent Application Publication
(10) Pub. No.: US 2023/0230041 A1
(43) Pub. Date: Jul. 20, 2023

(54) APPARATUS AND METHOD FOR MATCHING EMPLOYER TO JOB SEEKER BASED ON METAVERSE PLATFORM

(71) Applicant: UNIVERSITY OF ULSAN FOUNDATION FOR INDUSTRY COOPERATION, ULSAN (KR)

(72) Inventor: Byung Jik KIM, Ulsan (KR)

(73) Assignee: UNIVERSITY OF ULSAN FOUNDATION FOR INDUSTRY COOPERATION, ULSAN (KR)

(21) Appl. No.: 18/155,181

(22) Filed: Jan. 17, 2023

(30) Foreign Application Priority Data
Jan. 17, 2022 (KR) 1020220006277

(51) Int. Cl. G06Q 10/1053; G06Q 10/10; G06Q 30/0208; G06Q 50/00

(52) U.S. Cl. CPC G06Q 10/1053; G06Q 10/103; G06Q 30/0208; G06Q 50/01

(57) ABSTRACT

The present disclosure relates to an apparatus and a method for matching an employer to a job seeker based on a metaverse platform. According to the present disclosure, various experts are collected through an expert (user) pool, such that the knowledge and the experience are shared. The needs of the expert and the enterprise looking for the expert are satisfied through the expert platform. Information on the user is protected based on a blockchain technology.

### CROSS-REFERENCE TO RELATED APPLICATIONS

A claim for priority under 35 U.S.C. § 119 is made to Korean Patent Application No. 10-2022-0006277 filed Jan. 17, 2022 in the Korean Intellectual Property Office, the entire contents of which are hereby incorporated by reference.

### BACKGROUND

Embodiments of the inventive concept described herein relate to an apparatus related to a metaverse platform and a method for the same. More particularly, embodiments of the inventive concept relate to an apparatus and a method for matching an employer to a job seeker based on a metaverse platform.

Blockchain is introduced in the form of a Bitcoin-based technology at the initial stage, and has been explosively interested, as awareness of the unique characteristic of the blockchain technology, and the awareness of the possibility of use in various aspects spread over time. A financial industry first began to pay attention to the possibility of a blockchain, and various possibilities of use have been discussed not only in finance but also in the real economy and administration.

A Non-fungible tokens (NFT) have been emerged and played a role of collecting capital in a blockchain. The need to guarantee the right of digital content has been discussed for a long time, and the NFT based on the blockchain technology solves the problem in the long run. In addition, the NFT may not be substituted with other existing technologies. In addition, problems related to a transaction speed, transaction costs, and safe file management of digital content have been rapidly solved, as new blockchain-related applications have been developed.

In addition, a new virtual world that transcends reality has recently attracted attention as a new consumption market. An economist, which is a British business magazine, predicted the advent of the era of ‘Metaverse’ meaning “meta” and ‘verse’ and the spread of an eXtended reality (XR) technology to realize ‘Metaverse’. As predicted, offline activities, such as work, leisure, and communication, are rapidly moving into virtual spaces, as the COVID-19 pandemic breaks out.

### SUMMARY

Embodiments of the inventive concept provide a method for matching users to enterprises on a game platform.

More specifically, embodiments of the inventive concept provide a metaverse platform based on a game employing a blockchain and NFT, to match users to enterprises on a game platform

Problems to be solved by the inventive concept are not limited to the problems mentioned above, and other problems not mentioned will be clearly understood by those skilled in the art from the following description.

According to an embodiment, a method for matching an employer to a job seeker based on a metaverse platform, the method may include receiving, a transceiver of a server, information on a project related to an actual problem of an enterprise and a reward corresponding to the project from an enterprise server, receiving, by the transceiver, information on a solution to the project and information derived in a process of solving the project, from at least one user terminal of a plurality of user terminals, updating, by a processor of the server, information on a character corresponding to each of the plurality of users, transmitting, by the transceiver, the solution of the project to the enterprise server, and providing, by the processor of the server, the reward to a user terminal, which provides the solution to the project, of the plurality of terminals, when the solution to the project is selected by the enterprise. The reward includes at least one of a coin or token based on a blockchain, or a point for upgrading an ability or a skill of a user, the solution to the projector is derived through problem based learning, as the plurality of user terminals form a guild between the plurality of user terminals, each of the plurality of users is a job seeker who wants to get a job through the metaverse platform, the enterprise is an employer that wants to employ a person through the metaverse platform, the processor creates the character reflecting the ability and the skill of each of the plurality of users in the metaverse platform, upgrades the ability and the skill of a user solving the project, makes settings to assign a weight to an ability related to job performance required by the enterprise, and match a user, which has the job performance required by the enterprise, of the plurality of users with the enterprise, based on the ability and the skill of each of the plurality of users, the processor provides a weighted point to the user as the reward, when the user solves the project, such that the user upgrades the ability related to the job performance required by the enterprise, the processor allows the user to share the solution to the project and a progress for solving the project with other users through the metaverse platform in real time, and allows the other users to share information derived from a procedure of solving the project on the metaverse platform, such that the user learns the derived information, and the solution to the project, the progress for solving the project, and the information derived from the procedure of solving the project, which are shared, are implemented using a blockchain and a non-fungible token (NFT) to be protected as a digital asset.

In this case, the project may be designed to a single project, which is to be solved by a single user, or a team project to be solved by a team including team members of the plurality of users, the processor may determine the solution to the project as multiple solutions, when the project is the single project having multiple solutions uploaded within a previously defined time, determine a solution, which has a highest match rate with an expected answer uploaded in advance, of the multiple solutions as having first priority, and determine a solution of a user terminal having a highest project achievement rate in the server of the metaverse platform as having second priority, completion of the team project may be determined based on a time in which all partial solutions submitted by the team members are uploaded into the server of the metaverse platform, when a request is made to complete a plurality of projects within a previously defined time regarding the team project, and, the partial solutions may be determined to have higher priority, as the partial solutions are uploaded in the server of the metaverse platform earlier, and a contribution level of the partial solutions in completing the team project is higher.

In addition, the processor may issue a first NFT linked to a time point, at which a first solution to the project is uploaded, and intrinsic information of the user terminal uploading the first solution, when the project is determined as being first solved in the metaverse platform, issue a second NFT based on the intrinsic information of the user terminal and intrinsic information of the enterprise, when the user is matched to the enterprise through the metaverse platform, and issue a third NFT, based on the intrinsic information of the user terminal uploading the solution to the project and a proposer of the project, when the project having a previously defined difficulty is solved in the metaverse platform.

In this case, the processor may store data related to knowledge derived through the problem based learning, classify the stored data into visual data and language data, and collect log data of the classified data, based on machine learning, the stored data may include at least one a text, voice information, and activity log in the metaverse platform, or a web page searching record, which is received from the user terminal, and the processor may perform the machine learning by preprocessing the visual data through a convolution neural network (CNN) model, when the log data is collected based on the machine learning, and perform the machine learning by preprocessing the language data through a natural language processing (NLP) model.

In addition, the point may be obtained, as the user solves a quest or shares knowledge through a knowledge-sharing platform, and the knowledge-sharing platform may be a platform allowing persons to share knowledge between the persons in the server of the metaverse platform.

In addition, the guild may be formed based on a type of the project or an intent of a user, and a type of the guild may be determined, based on a scheme of solving the project. In detail, the reward, which corresponds to the project, distributed to the plurality of terminals included in the guild may be distributed depending on a contribution level of each of the plurality of users, when the project is solved. In more detail, the processor may generate an item for an enterprise generating the project, when the information on the character is updated, and when a first user terminal of the plurality of user terminals included in the guild solves the project, calculate log information of the first user terminal and correlation between the solution submitted by the first user terminal and the solution adapted by the enterprise, and update a first character corresponding to the first user terminal, based on the log information and the correlation, such that the item is added to the first character.

According to an embodiment, a server of a metaverse platform includes a transceiver to make communication between an enterprise server and a plurality of user terminals, and a processor to control an operation of matching the employer to the job seeker based on the metaverse platform. The processor may receive, through the transceiver, information on a project related to an actual problem of an enterprise and a reward corresponding to the project from the enterprise server, receive, through the transceiver, information on a solution to the project and information derived in a process of solving the project, from at least one user terminal of the plurality of user terminals, update information on a character corresponding to each of a plurality of users, transmit the solution to the project to the enterprise server, and provide the reward to a user terminal, which provides the solution to the project, of the plurality of terminals, when the solution to the project is selected by the enterprise, the reward may include at least one of a coin or token based on a blockchain, or a point for upgrading an ability or a skill of a user, the solution to the projector may be derived through problem based learning, as the plurality of user terminals form a guild between the plurality of user terminals, each of the plurality of users may be a job seeker who wants to get a job through the metaverse platform, the enterprise may be an employer that wants to employ a person through the metaverse platform, the processor may create the character reflecting the ability and the skill of each of the plurality of users in the metaverse platform, upgrade the ability and the skill of a user solving the project, makes settings to assign a weight to an ability related to job performance required by the enterprise, and match a user, which has the job performance required by the enterprise, of the plurality of users with the enterprise, based on the ability and the skill of each of the plurality of users, the processor may provide a weighted point to the user as the reward, when the user solves the project, such that the user upgrades the ability related to the job performance required by the enterprise, the processor may allow the user to share the solution to the project and a progress for solving the project with other users through the metaverse platform in real time, and allow the other users to share information derived from a procedure of solving the project on the metaverse platform, such that the user learns the derived information, and the solution to the project, the progress for solving the project, and the information derived from the procedure of solving the project, which are shared, may be implemented using a blockchain and a non-fungible token (NFT) to be protected as a digital asset.

In addition, a computer program stored in a computer-readable recording medium to implement and execute the inventive concept may be further included.

In addition, a computer-readable recording medium to record a computer program for execute a method for implementing the inventive concept may be further provided.

### BRIEF DESCRIPTION OF THE FIGURES

FIGS. 1A and 1B illustrate the concept of a blockchain;

FIG. 2 is a view illustrating a metaverse platform according to the inventive concept;

FIG. 3 is a flowchart illustrating a process for solving a problem based on a metaverse platform according to the inventive concept;

FIG. 4 is a flowchart illustrating operations of an enterprise server and a user terminal according to the inventive concept;

FIG. 5 is a view illustrating the metaverse platform implemented through an XR device according to the inventive concept; and

FIG. 6 is a block diagram illustrating a metaverse platform server according to the inventive concept.

### DETAILED DESCRIPTION

The same reference numerals will be assigned to the same components throughout the whole specification. In the following description of the present specification, all components are not described, and content well known in the art to which the present disclosure pertains or the duplication between embodiments will be omitted. In the specification, the terms “unit”, “˜module”, “˜member” or “˜block” may be implemented in software or hardware. According to embodiments, a plurality of units, a plurality of modules, a plurality of members, or a plurality of blocks can be implemented by using one component or one unit, one module, one member, or one block may include a plurality of components.

In the whole specification, when a certain part is “linked to”, “coupled to”, or “connected with” another part, the certain part may be directly linked to, coupled to or connected with the another part, and an indirection link, an indirection coupling, or an indirection connection includes a link, a coupling, or a connection through a wireless communication network.

It will be understood that the terms “comprises,” “comprising,” “includes” and/or “including,” when used herein, specify the presence of stated elements and/or components, but do not preclude the presence or addition of one or more other elements and/or components.

In the present specification, when a member is positioned on another member “surface” or “above”, this includes not only when the member is in contact with the other member, but also when another member is present between the two members.

In the specification, the term “first and/or second” will be used to distinguish between components, and the components are not limited to the above-described terminology.

The articles “a,” “an,” and “the” are singular in that they have a single referent, but the use of the singular form in the specification should not preclude the presence of more than one referent.

Reference numerals in steps are only for the illustrative purpose, and not used to describe the sequence of the steps. The steps may be replicated in a sequence different from a sequence, which is described, unless otherwise specified.

Hereinafter, the operating principle of the inventive concept and embodiments will be described with reference to accompanying drawings.

In the present specification, according to the inventive concept, a metaverse platform server, to which a plurality of user terminals employed by a plurality of users access , includes various devices to perform an operation and to provide an operation result to a user terminal, such that a project suggested by an enterprise is accomplished on a game-based metaverse platform. For example, according to the inventive concept, the metaverse platform server may include a computer, a server device, and a portable terminal or may be provided in any form of the computer, the server device, and the portable terminal, such that a project suggested by an enterprise is accomplished on a game-based metaverse platform.

In this case, the computer may include a laptop computer, a desktop computer, a tablet PC, and a slate PC having a web browser, and the server device, which is a server making communication with the external device to make communication to process information, may include an application server, a computing server, a database server, a file server, a game server, a mail server, a proxy server, and a web server. The portable terminal, which is, for example, a wireless communication device ensuring portability and mobility, may include, all kinds of handheld-based wireless communication devices, such as a Personal Communication System (PCS), a Global System for Mobile communications (GSM), a Personal Digital Cellular (PDC), a Personal Handyphone System (PHS), a Personal Digital Assistant (PDA), an International Mobile Telecommunication (IMT)-2000, a Code Division Multiple Access (CDMA)-2000, a W-Code Division Multiple Access (W-CDMA), a Wireless Broadband Internet (Wibro) terminal, or a wearable device such as a watch, a ring, a bracelet, an anklet, a necklace, glasses, contact lens, or a head-mounted-device (HMD).

The definition of the terminology used in the present disclosure is as follows.

A blockchain may be defined as a computer network-based technology to ensure the integrity and the trust of a transaction record through ‘a digitized public distributed ledger’, or a distributed ledger itself. Accordingly, in the blockchain, data generated in block unit is recorded in a digital ledger which may be accessed by anyone, such that the transaction details are transparently recorded, copied, and stored in several computers. Accordingly, the digital ledger may not manipulated or distorted.

The NFT refers to unique data which may not be exchanged for anything else, because each token has its own value. In addition, the NFT, which is data stored in the blockchain, is an intrinsic recognition value (Signature) assigned to digital content. In other words, the NFT is a token representing an intrinsic asset having a unique value, which is different from a fungible token, such as a virtual asset, including Bitcoin or Ethereum, traded with an equal value

The NFT may be issued using an Ethereum Request for Comment (ERC) protocol employed in an Ethereum network. The ERC is a standard for the requirements of Ethereum, and refers to a rule which should be followed, when the virtual asset is issued through Ethereum.

Metaverse, which is a compound word of virtual/transcendental (meta) and world/cosmos (universe), refers to a three-dimensional virtual world. Metaverse is mainly classified into an augmented reality (AR), a life logging (LG), a virtual world (VW), or a mirror world (MW).

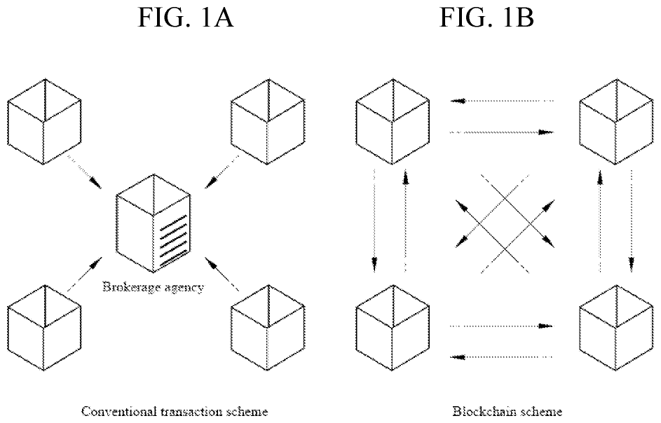

FIGS. 1A and 1B illustrate the concept of a blockchain.

Referring to FIG. 1A, according an existing transaction scheme, to make a transaction, a brokerage agency, such as a bank, is intervened. In this case, transaction details are also stored in the brokerage agency, such as a bank. Therefore, according to the generally known transaction scheme, the central (brokerage) agency has all transaction details.

FIG. 1B illustrates a transaction scheme employing a blockchain technology, in which a blockchain-based coin is traded in the form of a peer to peer (P2P) without the brokerage agency, and the transaction details are stored in a block instead of the brokerage agency.

Accordingly, the blockchain may be a storage platform designed to make it difficult for a specific person to arbitrarily manipulate data, as all members participating in the blockchain verify and store data from the members through a network.

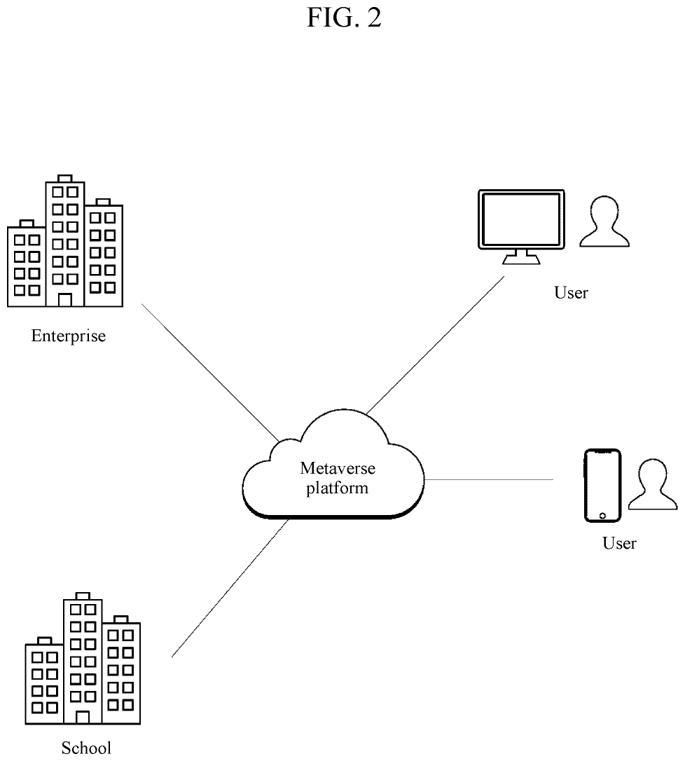

FIG. 2 is a view illustrating a metaverse platform according to the inventive concept.

Referring to FIG. 2, disclosed is a metaverse platform to match a platform user (a user, or a potential job seeker) to an employer (a subject, such as an enterprise or a school, to seek a person and to provide a project to be solved to the platform users while providing rewards to the platform users).

More specifically, according to the inventive concept, the metaverse platform may be a game-based platform and the employer may include various subjects, such as an enterprise or a school, to seek a person Although FIG. 2 illustrates only the enterprise or the school, the inventive concept is not limited thereto.

A user may use the metaverse platform through a terminal, and an enterprise and a school may also use the metaverse platform through a terminal, or a server.

The metaverse platform may be implemented by a server, and the user terminal and the enterprise server may be connected to the metaverse platform through network communication.

Game platform users may earn rewards by solving various real enterprise issues or solving projects suggested by enterprises. In this process, the users may share knowledge among users, which may be implemented in a metaverse platform.

Enterprises may provide projects (quest and, problems), which are to be solved by the enterprises, and rewards to the metaverse platform server in the form of outsourcing through enterprise servers. Game users on the metaverse platform may solve problems for themselves, by teaming up with other users, or by forming a guild to solve problems depending on the types of projects and may receive rewards for solving the problems (Play to Earn). In this process, it is obvious that users may solve the problems without forming the guild. The provided rewards may include not only coins in the blockchain, but also mileage scores (points) which may upgrade the user's own abilities or skills.

Data logs for solving problems may be recorded in a blockchain ledger illustrated in FIGS. 1A and 1B to obtain data integrity. For example, the data logs may include a history, such as chatting, voice conversation, an Internet visit history, and the share of a specific function on the platform, of all users to solve the problem.

Log data of a specific user may be generated in the form of a non-fungible token (NFT). For example, a data log of a first user who got a job at an enterprise through the metaverse platform according to the inventive concept, and a data log of a user who solves a specific project, which is difficult to solve, through the metaverse platform according to the inventive concept may be issued in the form of NFT.

Regarding the procedure of solving problems, users may utilize problem based learning (PBL) schemes to solve problems provided by an enterprise by forming a guild. The metaverse platform may also include a knowledge sharing platform in which users may learn using collective intelligence and exchange rewards in the PBL process. The users not only have the opportunity to share knowledge with other users or guilds who use the platform, but also obtain coins, abilities, and skills in the process of exchanging knowledge, through a knowledge sharing platform.

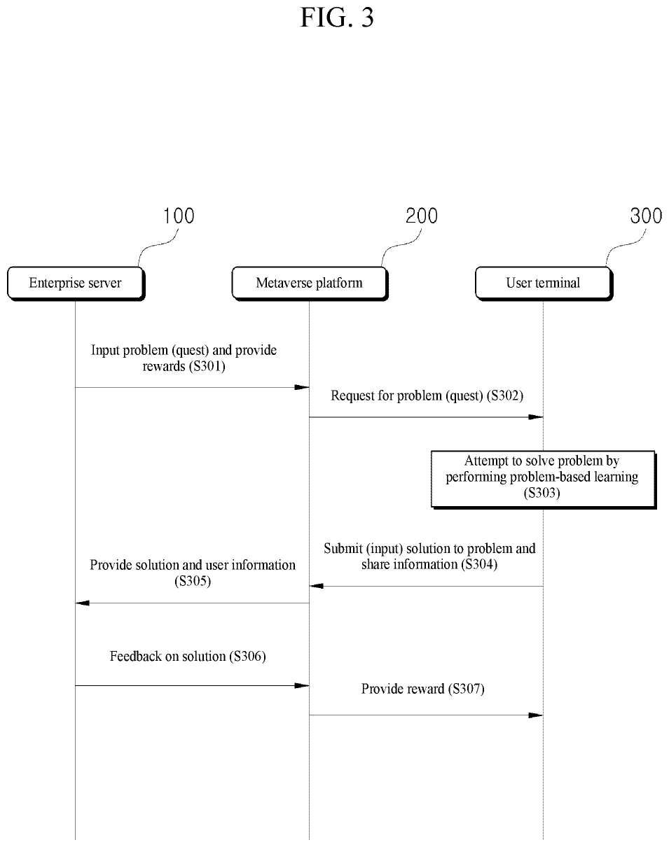

FIG. 3 is a flowchart illustrating a process for solving a problem based on a metaverse platform according to the inventive concept.

As illustrated in FIG. 3, an enterprise (an employer, or a problem provider) inputs a problem (quest) to a metaverse platform 200 according to the inventive concept through an enterprise server 100 and provides rewards given when the problem is solved (S301). According to an embodiment, the enterprise may provide a project for the PBL through a metaverse platform. Although FIG. 3 illustrates only the enterprise as the employer, the employer may include anyone, such as a self-employed person, a school, or a public institution, who wants to offer a job or solve a problem.

The following description will be made with reference to FIG. 3 regarding the operations between the enterprise server 100, the metaverse platform server 200, and the plurality of user terminals 300, in which an enterprise acts through the enterprise server 100, a user acts through a user terminal 300, and a metaverse platform may be implemented in the metaverse platform server 200. For example, providing information to the metaverse platform by the enterprise refers to transmitting, by the enterprise server 100, information or data to the metaverse platform server 200 through the connection to the metaverse platform server 200, and the metaverse platform server 200 receives the information or the data from the enterprise server 100. In addition, providing/inputting, by a user, information to the metaverse platform or receiving, by the user, information refers to transceiving between the user terminal 300 and the metaverse platform server 200, as the user terminal 300 is connected to the metaverse platform server 200.

Users who successfully accomplish projects provided by enterprises not only obtain coins, but also increase their capabilities or abilities. The enterprises may obtain talents having the most suitable job skills to the enterprises through the matching based on the abilities or skills of the users. In other words, the users may also receive a reward of getting a job.

Users are tested for the abilities or skills of the user over metaverse, and avatars reflecting the abilities or skills of the user are created on the metaverse platform. The users may create avatars (characters) of the users in a virtual space, which is called metaverse, in the metaverse platform server 200 connected through the user terminal 300 to make communication with other users or to create and trade digital content.

The abilities refers to the competence, such as power of logic, mathematical ability, the judgment of situation, human relationship ability, communication ability, emotional intelligence, leadership, creativity, and originality, which has been studied in existing psychology/education. According to an exemplary embodiment, the competence may be upgraded by solving a project designed by an enterprise. For example, a user may earn 10 points for the power of logic, 30 points for creativity, 50 points for communication skills, and 35 points for leadership by accomplishing a first project.

The skills may refer to a language skill, or a test or quest-solving skill, and may be increased through points obtained on a test, quest, and knowledge-sharing platform. The point is obtained, as the user solves a quest or shares knowledge through a knowledge-sharing platform, and the knowledge-sharing platform is a platform allowing persons to share knowledge between the persons in the server of the metaverse platform. According to an exemplary embodiment, the user may earn 10 points for the language skills in a relevant test and 30 points for the quest-solving ability in a specific field by earning points through a test pass or a knowledge-sharing platform

Regarding the details of rewards given when the problem is solved, avatars of users may have the attributes of a growing game character on the metaverse platform. In addition, the users may not only obtain block chain-based coins in the process of accomplishing an actual enterprise project suggested by the enterprise, but also upgrade ability attributes. The users may also get a job at an enterprise which provides a job that best is suitable for the abilities of the users, or wants the abilities of the users. The enterprise may hire users having the abilities necessary for a specific job (play to get a Job).

The metaverse platform server 200 requests the user terminal 300 to solve a problem (quest) (S302). In this case, the user may attempt to solve the problem or may solve the problem by performing problem-based learning (S303).

According to an embodiment, users who want to solve a problem may solve the problem for themselves as independent subjects, or may form a guild through user terminals owned by the users to perform PBL together. The metaverse platform server 200 may include an interaction training program for PBL.

The user may submit (input) a solution to a problem to the metaverse platform 200 through the user terminal 300, and share information related to the corresponding problem (S304). In this case, knowledge ownership may be guaranteed based on the blockchain and NFT to protect an individual knowledge In addition, the users may share problems, solutions, and problem-solving progresses of the user in real time or non-real-time through the metaverse platform server 200, and simultaneously learn knowledge shared by other users.

The metaverse platform server 200 provides a solution and information on a user (or guild or users) suggesting the solution, to the enterprise server 100 (S305).

The enterprise provides feedback on the solution to the metaverse platform server 200 again through the enterprise server 100 (S306), and the plurality of user terminals 300 connected to the metaverse platform server 200 may earn a reward by solving various actual enterprise issues or projects suggested by the enterprise (S307).

In this case, the reward may be a coin or token based on a blockchain, and may be a point for increasing the ability or the skills of a user.

Whether the project has been solved may be determined depending on whether the solution to the project is matched to a solution to the project, which is previously uploaded on the metaverse platform through the enterprise server 100.

Alternatively, whether the project has been solved may be determined depending on whether the project is a single project to be individually solved by a user or is a team project to be solved by a team including multiple users.

When the project is the single project having multiple solutions uploaded within a specific time, a solution, which has the highest match rate with an expected answer uploaded in advance, of the multiple solutions may be determined as having first priority, and a solution of a user terminal having the highest project achievement rate in the metaverse platform server may be determined as having second priority. In this case, the project achievement rate is the degree to which the user terminal contributes to solving the project.

When multiple projects are requested to be completed within a specific time with respect to a team project, a time point of completing the team project is determined based on a time point at which partial solutions submitted by team members are entirely uploaded to the metaverse platform server 200. The priority of the partial solutions is determined to be higher, as the time point of uploading the solution to the metaverse platform server 200 is earlier, and a contribution level in completing the team project is higher.

Hereinafter, the details of the coin or the token provided as a reward will be described.

The coin and the token are being issued as blockchain-based virtual assets.

The coin is issued through a mining process, and used as a means of the payment and the settlement of economical activities. The coin does not depend on an existing platform through an intrinsic blockchain network and is distributed through an independently established ecosystem.

The solution, the knowledge of the project, and the project-related data shared in the metaverse platform server 200 may be implemented in the form of a non-fungible token (NFT) and protected as a digital asset.

According to an exemplary embodiment, the metaverse platform server 200 may issue an NFT linked to a time point of uploading the first solution to the project and intrinsic data (log data derived in the process for a user to perform a project; the log data is an activity performed by a user through a terminal of the user) of the user uploading the first solution, when the project is determined as being first solved on the metaverse platform.

The metaverse platform server 200 may issue an NFT based on intrinsic information (user personal information) of a user terminal and intrinsic information of an enterprise, when the user and the enterprise make an employment agreement through the metaverse platform.

The metaverse platform server 200 may issue an NFT, based on the intrinsic information of the user terminal uploading the solution to the project and information on a proposer of a project, when a project having a difficulty (level) or more, which is predefined in the metaverse platform, is solved.

According to an embodiment of the present disclosure, log data (a voice or a text) to solve the problem of the user is stored in a server.

In this case, only necessary data may be collected based on an artificial intelligence (AI) technology including an image-based learning model in a convolutional neural network (CNN) and a natural language-based learning model through natural language processing (NLP). For example, the log data may be processed through an artificial intelligence learning methodology. In detail, data may be extracted, treated, and processed, based on Deep Learning. The log data is secured with data integrity through the nodeization of the blockchain. In addition, a coin is issued as a reward for the proof of stake (POS) and the proof of work (POW) of a node and a transaction.

In this case, the proof of stake (PoS) is an agreement algorithm which provides decision-making authority in proportion to the share ratio holding the cryptocurrency. In addition, the proof of work (PoW) is a consensus algorithm of proving the participating in a relevant project by counties sly iterating a process of finding a hash below a target value.

A token may also be interpreted as a virtual asset in a wider sense than the sense of a coin, and may be issued for a specific purpose (role) such as the compensation for a game or the transaction of an artwork. The coin is used in a blockchain-based decentralized application, and an issuer may adjust an amount of coin to be supplied. The token is mainly classified into two types of a fungible token and a non-fungible token.

The NFT is a token which guarantees the scarcity of an asset, proves the originality of the asset, and secures integrity because it is impossible to forge or alter data such as owner information and a transaction history.

When the reward is given in the form of an NFT, metadata and information of a digital asset are distributed and stored in a participating node through a blockchain network. Accordingly, forgery is difficult, and all transaction details from the first issuer to the present owner may be tracked.

In detail, digital assetization is possible by NFTizing monumental events in the metaverse. According to an exemplary embodiment, events, such as first player recruitment log of an enterprise, a first quest resolution moment of a legendary player, and the resolution of a millennium problem may be NFTized and protected by digital assets.

According to an exemplary embodiment, the metaverse platform server 200 stores data related to knowledge derived using problem-based learning and classifies data related to knowledge derived using problem-based learning as visual data and language data. The metaverse platform server 200 collects log data of data based on machine learning. In this process, the metaverse platform server 200 performs the machine learning by preprocessing visual data through a convolution neural networks (CNN) model, and performs machine learning by preprocessing language data through a natural language processing (NLP) model.

The metaverse platform server 200 may select a project participant based on log data. Specifically, the metaverse platform server 200 may select a user suitable for the project and allow the user to participate in the project by performing machine learning based on log data.

According to an exemplary embodiment, when a specific user performs most part of an activity based on a text, even if the enterprise suggesting the project wants a solution to the media-related project, the metaverse platform server may filter out the specific user, such that the specific user is not selected for the media-related project.

According to another embodiment, when determining position data measured through a GPS module of a specific user terminal or motion data measured through a gyro sensor, as being in an inactive state because the position data and the motion data have no change equal to or greater than a threshold value, even if the enterprise suggesting the project desires a user to personally act and to solve the project, the metaverse platform server 200 may filter out the user, such that the user is not selected for the media-related project.

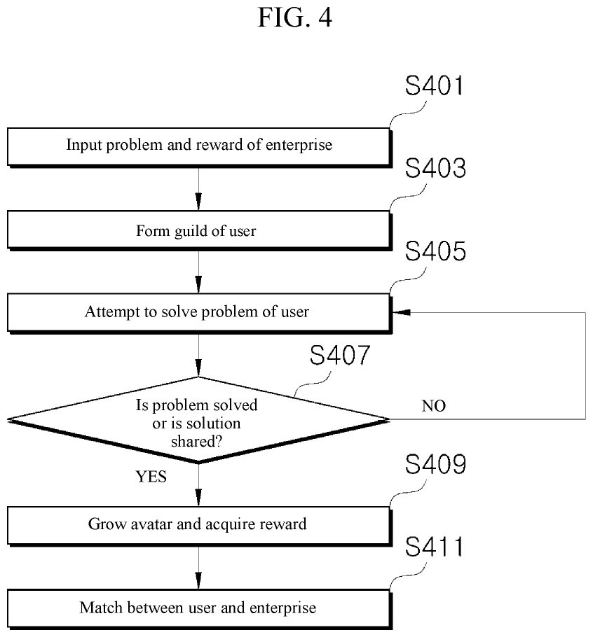

FIG. 4 is a flowchart illustrating operations of an enterprise server and a user terminal according to the inventive concept.

The enterprise server 100 inputs a problem (quest) to be solved and a reward obtained when a problem is solved, into the metaverse platform server 200 (S401). In other words, the metaverse platform server 200 receives information on the problem and the reward when the problem is solved, from the enterprise server 100. In this case, the problem may be the project described above, or may include a specific mission or a specific quest.

In this case, the enterprise may design the ability score to be assigned when a problem (a quest, or a project) is solved through a job description. More specifically, the ability may include at least one of power of logic, mathematical ability, the judgment of situation, human relationship ability, communication ability, emotional intelligence, leadership, creativity, originality, affinity, or responsibility. The point which may upgrade the ability may be designed to assign a weight to each item of the ability necessary to solve the problem.

According to an exemplary embodiment, when a problem requiring creativity as an important factor is solved, 100 points for creativity, 50 points for communication, and 20 points for responsibility are provided. According to another embodiment, when a problem requiring responsibility as an important factor is solved, 20 points for creativity, 50 points for communication, and 100 points for responsibility are provided. The score of the ability may be set as desired by the enterprise.

Regarding a quest (a project, or a problem), an enterprise may freely design the quest, for example, may design whether the problem is solved by a single person or a team, and whether a first-come, and first-served basis or multiple answers are accepted in solving the problem.

In addition, when the value of a specific ability (creativity, communication ability, or responsibility) is equal to or greater than a reference point, a design may be made to provide a reward to a user (player) submitting the solution to the specific quest or to employ the user. The point for improving the ability value is provided to a user terminal, as the user solves the quest or shares knowledge through a knowledge-sharing platform.

A plurality of users form a guild on a metaverse platform server 200 to solve a problem (quest) through relevant user terminals 300 of the users (S403) to attempt to solve the problem (S405). In addition, the user terminal 300 generates a user character on the metaverse platform server 200.

The guild may be formed depending on the type of a problem or a user intent. In addition, the guild may be formed in different types depending on the problem-solving scheme.

According to an exemplary embodiment, a P guild may be a guild which solves a problem on an AI basis, and a Q guild may be a guild which solves a problem with humanities and management approaches.

Rewards formed as the problem is solved may be autonomously distributed to users in the guild. For example, for an A guild, the rewards may be equally distributed to users included in the guild A regardless of the contribution level of the user. For a B guild, the rewards may be differentially distributed to the users in the B guild.

The user terminal 300 may transmit, to the metaverse platform server 200, a solution to the problem and information on knowledge derived from the process of solving the problem. The metaverse platform server 200 allows all users to share the solution or allows only the enterprise to share the solution (S407). In other words, the user terminal 300 transmits the data corresponding to the solution to the user terminal 300 and the enterprise server 100 connected to the platform server 200.

When the enterprise selects the solution to the problem and the problem is solved, an avatar of the user is grown and obtains a reward (S409). The reward may be provided by adding a point to abilities and skills. Alternatively, the reward may be provided through the matching between a user submitting a solution and an enterprise suggesting a problem (S411).

In this case, the ability includes the power of logic, mathematical ability, the judgment of situation, human relationship ability, communication ability, emotional intelligence, leadership, creativity, originality, affinity, or responsibility.

The skill includes foreign language proficiency, scores of an internal test, and points obtained from the quest or Research Society.

Rewards distributed to a plurality of user terminals included in the guild is equally distributed to the plurality of user terminals or are distributed depending on the contribution level of each of the plurality of users contributing to solving the problem.

Contents, such as an item or a badge, for identifying a character or a guide of the user terminal 300 may be used, separately from a point.

In detail, the metaverse platform server 200 creates an item for an enterprise or a person generating a project, when a first user terminal included in the plurality of user terminals 300 solves the project. The metaverse platform server 200 updates a character corresponding to the first user terminal of the metaverse platform server 200 such that the item is added with respect to the character.

Various items or various badges may be employed depending on the types of projects. For example, when the user terminal 300 solves the project related to the media content, the metaverse platform server 200 may provide an item related to media content to the character of the user terminal.

The enterprise server 100 may select a character suitable for a human resource image desired by the enterprise, based on an item or badge.

The following description will be made regarding a manner of distributing ability, a skill, and an item, when the guild solves a project or a problem. When the problem is not solved by a single user terminal, a problem may be caused in the distribution of a reward.

According to an exemplary embodiment, the reward may be determined based on (1) the log of the user terminal 300 and (2) the correlation obtained by comparing data, which is generated from the user terminal 300 submitting the solution, with data related to a solution employed by an enterprise.

For example, as the log of the user terminal 300 is greater, the degree or priority of the reward is increased. In addition, as the correlation between the solution submitted by the user terminal and the selected solution is increased, the degree of the reward or the priority for the reward is first provided.

When the rewards are divided and distributed, for example, when the rewards are points, as the log of the user terminal 300 is greater or the correlation is increased, more points are distributed.

When the rewards are not divided to be distributed, for example, when only one item is provided, or when different types of items or badges are provided, as the log of the user terminal 300 is greater or the correlation is increased, the right of selection for the item or the badge is first given.

Research Society refers to a platform to solve the problem and to share knowledge in the metaverse platform sharing the knowledge between users. The users may obtain basic knowledge necessary for solving the problem suggested by an enterprise through Research Society, and may share the knowledge to develop the knowledge. Students in underdeveloped or developing countries may be trained corresponding to the regular curriculum by learning how to learn and solve problems through the Research Society. In this case, a reward, such as a coin, may be obtained only through the learning in the Research Society with the support of the enterprise.

In addition, Research Society may not only share knowledge, but also directly buy and sell knowledge. Enterprises may pay for knowledge and obtain the latest knowledge in the Research Society. The knowledge providers may directly sell the knowledge of the knowledge providers. For example, it is possible to communityiz solving all human problems, such as the Millennium Problem (7 challenges) of the Clay Mathematics Institute.

Furthermore, a user may perform the entire life process, such as learning, employment, research, income creation, and networking, on the present metaverse platform. In other words, the present metaverse platform may implement Digital Life Twin.

Regarding the description with reference to FIG. 4, the operations as in FIG. 4 may include the operations between the enterprise server 100, the metaverse platform server 200, and the user terminal 300, the enterprise may operate through the enterprise server 100, the user may operate through the user terminal 300, and the metaverse platform and the knowledge sharing platform may be implemented in the server 200.

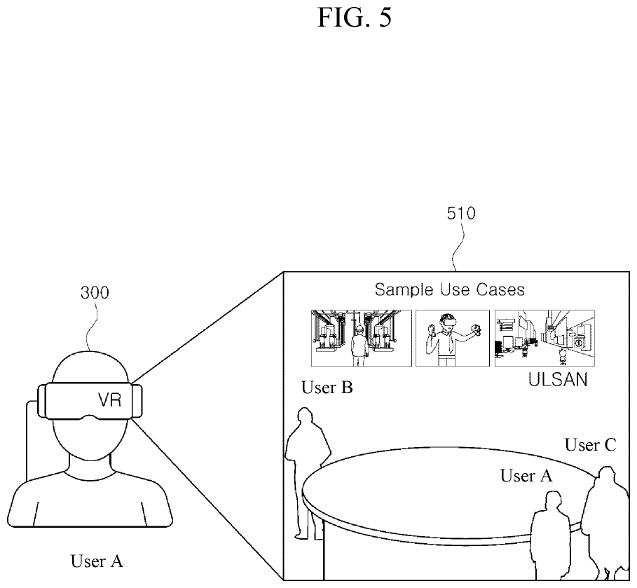

FIG. 5 is a view illustrating the metaverse platform implemented through an XR device according to the inventive concept.

Referring to FIG. 5, a virtual reality (VR) device is illustrated by way of example of an XR according to the inventive concept. In this case, the XR device may be employed as the user terminal 300.

The VR device may be implemented in the form of a head mounted device (HMD), a head-up display (HUD) provided in a vehicle, a television, a smartphone, a computer, a wearable device, a home appliance, a digital signage, a vehicle, or a robot.

The VR device may transmit and receive a signal (e.g., media data, or a control signal) with external devices such as another wireless device, a portable device, or a media server (a server to implement a platform). The media data may include a video, an image, or a sound.

The VR device may obtain control information or data from the metaverse platform server 200 and may output a VR object created. The input/output unit included in the VR device to input or output data may include a camera, a microphone, a user input unit, a display unit, a speaker and/or a haptic module.

When a user tries to receive and view data, which are provided by the metaverse platform server 200, through a VR device, the VR device may transmit information on a request for content to the metaverse platform server 200 through the communication unit of the VR device. The VR device may receive, in a downloading/streaming form, content such as a project and audio-visual material, from the metaverse platform 200.

A user may generate a character (user A) in the metaverse platform server 200 through the user terminal 300, and the VR device may display a character generated from the metaverse platform server 200. Referring to FIG. 5, the user may identify characters (user B or user C) of other users on the metaverse platform, and a project 510 suggested by a subject (for example, an enterprise) suggesting a project, through a display unit of the VR device with a naked eye.

In addition, although not illustrated in FIG. 5, the VR device is wirelessly connected to the portable device through the communication unit, and the operation of the VR device may be controlled by the portable device. For example, a portable device may operate as a controller for the VR device. To this end, the VR device may generate and output an XR object corresponding to the portable device, after obtaining 3D position information of the portable device. Although the VR device and the portable device have been described separately, the VR device may also serve as the portable device. In other words, the user terminal has a concept including at least one of a VR device and a portable device.

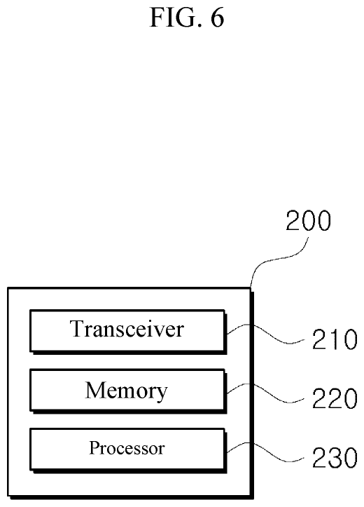

FIG. 6 is a block diagram illustrating a metaverse platform server according to the inventive concept.

Referring to FIG. 6, the metaverse platform server 200, which is the apparatus according to the inventive concept, may include a transceiver 210, a memory 220, and a processor 230. The components illustrated in FIG. 6 are not essential for implementing the apparatus according to the inventive concept, and thus the apparatus described herein may have more or less components than those listed above.

The transceiver 210 may include at least one component allowing the communication between the server 100 and the user terminal 300. For example, the transceiver 210 may include at least one of a broadcast receiving module, a wired communication module, a wireless communication module, a short-range communication module, and a position information module.

Specifically, the wired communication modules include various cable communication modules, such as a universal serial bus (USB), a high definition multimedia interface (HDMI), a digital visual interface (DVI), a recommended standard 232 (RS-232), power line communication or a plan old telephone service (POTS), in addition to various wired communication modules, such as a local area network (LAN) module, a wide area network (WAN) module, or a value added network (VAN) module.

Specifically, a wireless communication module may include a wireless communication module to support various wireless communication schemes, such as Global System for Mobile Communication (GSM), Code Division Multiple Access (CDMA), Wideband Code Division Multiple Access (WCDMA), universal mobile telecommunications system (UMTS), Time Division Multiple Access (TDMA), Long Term Evolution (LTE), fourth-generation, fifth generation, or sixth generation, in addition to a WiFi module, or a wireless broadband module.

The memory 220 may store data for supporting various functions of the metaverse platform server 200, a program for operation of the processor 230, multiple applications (an application program or an application) run in the metaverse platform server 200, and data and commands for operation of the metaverse platform server 200. At least some of the application programs may be downloaded from an external server through wireless communication.

The memory may include at least one of a flash memory type, a hard disk [0061] type, a solid state disk type (SSD), a Silicon Disk Drive (SDD) type), a multimedia card micro type, a card type memory (e.g. SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk-type storage medium. In addition, the memory, which is separated from the apparatus herein, may be a database connected in a wired or wireless manner.

The processor 230 may control any one of components described above or the combination of the components, to implement various embodiments of the present disclosure described with reference to FIGS. 1A to 5 on the metaverse platform server 200.

According to an exemplary embodiment, the transceiver 210 may receive information on a project related to the actual problem of the enterprise and a reward corresponding to the project from the enterprise server 100.

In addition, the transceiver 210 may receive information on a solution to a project and the knowledge derived in the process of solving the project, from at least one user terminal among the plurality of user terminals 300, and transmit the solution to the enterprise server 100.

In this case, the processor 230 may share the solution to the project and the knowledge with the plurality of user terminals 300 through the transceiver 210. When the solution to the project is selected by the enterprise, the processor 230 may provide a reward to the relevant user terminal.

The memory 220 may store data generated in the process of solving the project based on problem-based learning.

According to various embodiments of the inventive concept, the processor 230 may perform an operation of determining whether a user is qualified or is a proxy to use the user terminal.

According to an exemplary embodiment, the processor 230 may determine “abusing” to determine a specific behavior of the user, for example, misuse and abuse of the project, and whether the project is solved by the proxy. When a specific user terminal acts differently from a conventional learned pattern in the metaverse platform server, and when a user using the specific user terminal is not determined as being an existing user, as the difference is equal to or greater than a specific threshold value, the processor 230 may determine the user terminal as being abused.

When a user terminal, which has searched for something in Korean, searches for something in English, when a user terminal visits a site through a route, which has never been undergone, and refers to the site, or when a voice waveform is different from an existing voice waveform of the user, the processor 230 determines that a specific condition for determining “abusing” is satisfied.

When the specific condition is satisfied, the processor 230 may inquire about personal information of a user to a user terminal to verify the user by changing a situation condition and at least one of conditions in the metaverse platform server 200, or may make a request for the verification of the identity of a team member.

When “abusing” is determined, based on the feedback resulting from the inquiry about the personal information or the request for the verification of the identity of the team member, the processor 230 restricts a character (avatar) corresponding to the user terminal determined as being abused.

For example, the processor 230 may generate an item (a mark for determining “abusing”) to be forcibly worn by a relevant character, may withdraw a project assigned to a relevant user terminal, or may reduce rewards resulting from a solution to a problem under a changed environment.

According to various embodiments of the present disclosure, the processor 230 may perform an assist operation for easily solving a project.

According to an exemplary embodiment, the processor 230 may change at least one of an internal situation or an internal condition of the metaverse platform server 200, when a problem (project) received from the enterprise server 100 is not solved for a specific period (a preset period).

For example, the processor 230 determines that the intervention of an administrator (server) is necessary, when an amount of user log data for accessing or solving a project is determined as being less than or equal to a threshold value. The administrator managing the metaverse platform server 200 lowers a difficulty of the relevant project through the metaverse platform 200). In other words, the processor 230 may replace the relevant project with a second project which has been previously created, may increase the amount and quality of a reward, or may expose the project to users more on the metaverse platform.

In addition, the processor 230 may create a character reflecting the ability and the skill of each of a plurality of users in a metaverse platform, may upgrade the ability and the skill of a user solving the project, may make settings to assign a weight to an ability related to job performance required by the enterprise, and may match a user, which has the job performance required by the enterprise, of the plurality of users to the enterprise, based on the ability and the skill of each of the plurality of users.

In addition, the processor 230 may provide a weighted point to a user as a reward, when the user solves the project, such that the user upgrades the ability related to the job performance required by the enterprise.

In addition, the processor 230 allows the user to share the solution to the project and a progress for solving the project with other users through the metaverse platform in real time, through the user terminal and allows the other users to share information derived from the procedure of solving the project in the metaverse platform, such that the user learns the derived information. In this case, the solution to the project, the progress for solving the project, and the information derived from the procedure of solving the project, which are shared, are implemented using a blockchain and an NFT to be protected as a digital asset.

In this case, the project is designed to a single project, which is to be solved by a single user, or a team project to be solved by a team including team members of the plurality of users. When the project is the single project having multiple solutions uploaded within a previously defined time, the processor 230 may determine the solution to the project as multiple solutions, determine a solution, which has the highest match rate with an expected answer uploaded in advance, of the multiple solutions as having first priority, and a solution of a user terminal having the highest project achievement rate in the metaverse platform server may be judged as having second priority.

In this case, when a request is made to complete a plurality of projects within a previously defined time regarding a team project, the completion of the team project may be determined based on a time in which all partial solutions submitted by the team members are uploaded into the metaverse platform server 200, and the partial solutions may be determined to have higher priority, as the partial solutions are uploaded in the metaverse platform server 200 earlier, and the contribution level of the partial solutions in completing the team project is higher

In addition, when the project is determined as being first solved in the metaverse platform, the processor 230 issues a first NFT linked to a time point, at which the first solution to the project is uploaded, and intrinsic information of the user terminal uploading the first solution. In addition, when the user is matched to the enterprise through the metaverse platform, the processor 230 issues a second NFT based on the intrinsic information of the user terminal and the intrinsic information of the enterprise. When the project having a previously defined difficulty is solved in the metaverse platform, the processor 230 may issue a third NFT is issued, based on the intrinsic information of the user terminal uploading the solution to the project and a proposer of the project.

In addition, the processor 230 may store data related to the knowledge derived from the problem-based learning, may classify the stored data into visual data and language data, and may collect log data of the classified data based on machine learning. The stored data may include at least one a text, voice information, and activity log in the metaverse platform, and a web page searching record.

In this case, when the log data is collected based on machine learning, the processor 230 may perform machine learning by preprocessing the visual data through a convolution neural network (CNN) model, and may perform machine learning by preprocessing the language data through a natural language processing (NLP) model.

In this case, the guild may be formed based on the type of the project or the user intent. The type of the guild may be determined based on the scheme for solving the project. The rewards, which correspond to the project, distributed to the plurality of terminals included in the guild may be distributed depending on the contribution level of each of the plurality of users when the project is solved.

In this case, when the information on the character is updated, and when a first user terminal of the plurality of user terminals in the guild solves the project, the processor 230 may generate an item for an enterprise suggesting the project, may calculate log information of the first user terminal and the correlation between the solution submitted by the first user terminal and the solution adapted by the enterprise, and may update a first character corresponding to the first user terminal, based on the log information and the correlation, such that the item is added to the first character.

At least one component may be added or deleted to correspond to the performance of components of the apparatus illustrated in FIG. 6. It may be easily understood by those skilled in the art that the relative positions of the components may be changed to correspond to the performance or the structure of the system.

Meanwhile, components illustrated in FIG. 6 refer to software components and/or hardware components such as a field programmable gate array (FPGA) and an application specified integrated circuit (ASIC).

Meanwhile, disclosed embodiments may be implemented in the form of a recording medium to store an instruction executable by the computer. The instruction may be stored in the form of a program code. When the instruction is executed by a processor, the operation of embodiments disclosed by creating a program module will be performed. The recording medium may be implemented in the form of a recording medium readable by a computer.

The recording medium readable by the computer includes all type of recording media having an instruction decrypted by the computer. For example, the recording medium may include a read only memory, a random access memory (RAM), a magnetic tape, a magnetic disc, a flash memory, and an optical data storage device.

As described above, according to the present disclosure, the enterprise and the user may be efficiently matched depending on an ability to solve the problem based on problem-based learning.

In addition, according to the present disclosure, various experts are collected through an expert (user) pool, such that the knowledge and the experience are shared. In addition, the expert and the needs of the enterprise looking for the expert may be satisfied through the expert platform.

In addition, according to the present disclosure, information on a user may be protected based on a blockchain technology.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Disclosed embodiments are provided only for the illustrative purpose, and the inventive concept should not be interpreted to be limited.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for matching an employer to a job seeker based on a metaverse platform by a server, the method comprising:
receiving, a transceiver of the server, information on a project related to an actual problem of an enterprise and a reward corresponding to the project from an enterprise server;
receiving, by the transceiver, information on a solution to the project and information derived in a process of solving the project, from at least one user terminal of a plurality of user terminals;
updating, by a processor of the server, information on a character corresponding to each of the plurality of users;
transmitting, by the transceiver, the solution of the project to the enterprise server; and
providing, by the processor of the server, the reward to a user terminal, which provides the solution to the project, of the plurality of terminals, when the solution to the project is selected by the enterprise,
wherein the reward includes at least one of a coin or token based on a blockchain, or a point for upgrading an ability or a skill of a user,
wherein the solution to the projector is derived through problem-based learning, as the plurality of user terminals form a guild between the plurality of user terminals,
wherein each of the plurality of users is a job seeker who wants to get a job through the metaverse platform,
wherein the enterprise is an employer that wants to employ a person through the metaverse platform,
wherein the processor is configured to create the character reflecting the ability and the skill of each of the plurality of users in the metaverse platform; upgrade the ability and the skill of a user solving the project, makes settings to assign a weight to an ability related to job performance required by the enterprise; and match a user, which has the job performance required by the enterprise, of the plurality of users with the enterprise, based on the ability and the skill of each of the plurality of users,
wherein the processor is configured to: provide a weighted point to the user as the reward, when the user solves the project, such that the user upgrades the ability related to the job performance required by the enterprise,
wherein the processor is configured to: allow the user to share the solution to the project and a progress for solving the project with other users through the metaverse platform in real time; and allow the other users to share information derived from a procedure of solving the project on the metaverse platform, such that the user learns the derived information, and
wherein the solution to the project, the progress for solving the project, and the information derived from the procedure of solving the project, which are shared, are implemented using a blockchain and a non-fungible token (NFT) to be protected as a digital asset.

2. The method of claim 1, wherein the project is designed to a single project, which is to be solved by a single user, or a team project to be solved by a team including team members of the plurality of users,
wherein the processor is configured to: determine the solution to the project as multiple solutions, when the project is the single project having multiple solutions uploaded within a previously defined time; determine a solution, which has a highest match rate with an expected answer uploaded in advance, of the multiple solutions as having first priority; and determine a solution of a user terminal having a highest project achievement rate in the server of the metaverse platform as having second priority,
wherein completion of the team project is determined based on a time in which all partial solutions submitted by the team members are uploaded into the server of the metaverse platform, when a request is made to complete a plurality of projects within a previously defined time regarding the team project, and
wherein the partial solutions are determined to have higher priority, as the partial solutions are uploaded in the server of the metaverse platform earlier, and a contribution level of the partial solutions in completing the team project is higher.

3. The method of claim 2, wherein the processor is configured to:
issue a first NFT linked to a time point, at which a first solution to the project is uploaded, and intrinsic information of the user terminal uploading the first solution, when the project is determined as being first solved in the metaverse platform;
issue a second NFT based on the intrinsic information of the user terminal and intrinsic information of the enterprise, when the user is matched to the enterprise through the metaverse platform; and
issue a third NFT, based on the intrinsic information of the user terminal uploading the solution to the project and a proposer of the project, when the project having a previously defined difficulty is solved in the metaverse platform.

4. The method of claim 3, wherein the processor is configured to:
store data related to knowledge derived through the problem-based learning;
classify the stored data into visual data and language data; and
collect log data of the classified data, based on machine learning,
wherein the stored data includes at least one a text, voice information, and activity log in the metaverse platform, or a web page searching record, which is received from the user terminal, and
wherein the processor is configured to: perform the machine learning by preprocessing the visual data through a convolution neural network (CNN) model, when the log data is collected based on the machine learning; and perform the machine learning by preprocessing the language data through a natural language processing (NLP) model.

5. The method of claim 1, wherein the point is obtained, as the user solves a quest or shares knowledge through a knowledge-sharing platform, and
wherein the knowledge-sharing platform is a platform allowing persons to share knowledge between the persons in the server of the metaverse platform.

6. The method of claim 1, wherein the guild is formed based on a type of the project or an intent of a user, and
wherein a type of the guild is determined, based on a scheme of solving the project.

7. The method of claim 6, wherein the reward, which corresponds to the project, distributed to the plurality of terminals included in the guild is distributed depending on a contribution level of each of the plurality of users, when the project is solved.

8. The method of claim 7, wherein the processor is configured to:
generate an item for an enterprise generating the project, when the information on the character is updated, and when a first user terminal of the plurality of user terminals included in the guild solves the project;
calculate log information of the first user terminal and correlation between the solution submitted by the first user terminal and the solution adapted by the enterprise; and
update a first character corresponding to the first user terminal, based on the log information and the correlation, such that the item is added to the first character.

9. A non-volatile computer-readable recording medium to store a program for executing the method for matching the employer to the job seeker based on the metaverse platform according to claim 1.

10. An apparatus for matching an employer to a job seeker based on a metaverse platform, the apparatus comprising:
a transceiver configured to make communication between an enterprise server and a plurality of user terminals; and
a processor configured to control an operation of matching the employer to the job seeker based on the metaverse platform,
wherein the processor is configured to:
receive, through the transceiver, information on a project related to an actual problem of an enterprise and a reward corresponding to the project from the enterprise server;
receive, through the transceiver, information on a solution to the project and information derived in a process of solving the project, from at least one user terminal of the plurality of user terminals;
update information on a character corresponding to each of the plurality of users;
transmit the solution to the project to the enterprise server; and
provide the reward to a user terminal, which provides the solution to the project, of the plurality of terminals, when the solution to the project is selected by the enterprise,
wherein the reward includes at least one of a coin or token based on a blockchain, or a point for upgrading an ability or a skill of a user,
wherein the solution to the projector is derived through problem-based learning, as the plurality of user terminals form a guild between the plurality of user terminals,
wherein each of the plurality of users is a job seeker who wants to get a job through the metaverse platform,
wherein the enterprise is an employer that wants to employ a person through the metaverse platform,
wherein the processor is configured to create the character reflecting the ability and the skill of each of the plurality of users in the metaverse platform; upgrade the ability and the skill of a user solving the project, makes settings to assign a weight to an ability related to job performance required by the enterprise; and match a user, which has the job performance required by the enterprise, of the plurality of users with the enterprise, based on the ability and the skill of each of the plurality of users,
wherein the processor is configured to: provide a weighted point to the user as the reward, when the user solves the project, such that the user upgrades the ability related to the job performance required by the enterprise,
wherein the processor is configured to: allow the user to share the solution to the project and a progress for solving the project with other users through the metaverse platform in real time; and allow the other users to share information derived from a procedure of solving the project on the metaverse platform, such that the user learns the derived information, and
wherein the solution to the project, the progress for solving the project, and the information derived from the procedure of solving the project, which are shared, are implemented using a blockchain and a non-fungible token (NFT) to be protected as a digital asset.

11. The apparatus of claim 10, wherein the project is designed to a single project, which is to be solved by a single user, or a team project to be solved by a team including team members of the plurality of users,
wherein the processor is configured to: determine the solution to the project as multiple solutions, when the project is the single project having multiple solutions uploaded within a previously defined time; determine a solution, which has a highest match rate with an expected answer uploaded in advance, of the multiple solutions as having first priority; and determine a solution of a user terminal having a highest project achievement rate in the server of the metaverse platform as having second priority,
wherein completion of the team project is determined based on a time in which all partial solutions submitted by the team members are uploaded into the server of the metaverse platform, when a request is made to complete a plurality of projects within a previously defined time regarding the team project, and
wherein the partial solutions are determined to have higher priority, as the partial solutions are uploaded in the server of the metaverse platform earlier, and a contribution level of the partial solutions in completing the team project is higher.

12. The apparatus of claim 11, wherein the processor is configured to:
issue a first NFT linked to a time point, at which a first solution to the project is uploaded, and intrinsic information of the user terminal uploading the first solution, when the project is determined as being first solved in the metaverse platform;
issue a second NFT based on the intrinsic information of the user terminal and intrinsic information of the enterprise, when the user is matched to the enterprise through the metaverse platform; and
issue a third NFT, based on the intrinsic information of the user terminal uploading the solution to the project and a proposer of the project, when the project having a previously defined difficulty is solved in the metaverse platform.

13. The apparatus of claim 12, wherein the processor is configured to:
store data related to knowledge derived through the problem-based learning;
classify the stored data into visual data and language data; and
collect log data of the classified data, based on machine learning,
wherein the stored data includes at least one a text, voice information, and activity log in the metaverse platform, or a web page searching record, which is received from the user terminal, and
wherein the processor is configured to: perform the machine learning by preprocessing the visual data through a convolution neural network (CNN) model, when the log data is collected based on the machine learning; and perform the machine learning by preprocessing the language data through a natural language processing (NLP) model.

14. The apparatus of claim 10, wherein the point is obtained, as the user solves a quest or shares knowledge through a knowledge-sharing platform, and
wherein the knowledge-sharing platform is a platform allowing persons to share knowledge between the persons in the server of the metaverse platform.

15. The apparatus of claim 10, wherein the guild is formed based on a type of the project or an intent of a user, and
wherein a type of the guild is determined, based on a scheme of solving the project.

16. The apparatus of claim 15, wherein the reward, which corresponds to the project, distributed to the plurality of terminals included in the guild is distributed depending on a contribution level of each of the plurality of users, when the project is solved.

17. The apparatus of claim 16, wherein the processor is configured to:
generate an item for an enterprise generating the project, when the information on the character is updated, and when a first user terminal of the plurality of user terminals included in the guild solves the project;
calculate log information of the first user terminal and correlation between the solution submitted by the first user terminal and the solution adapted by the enterprise; and
update a first character corresponding to the first user terminal, based on the log information and the correlation, such that the item is added to the first character.
